(19) United States
(12) Patent Application Publication
(10) Pub. No.: US 2025/0347396 A1
(43) Pub. Date: Nov. 13, 2025

(54) ALTERNATE JUNCTION BOX AND ARRANGEMENT FOR LIGHTING APPARATUS

(71) Applicant: DMF, Inc., Carson, CA (US)

(72) Inventors: Amir Lotfi, Redondo Beach, CA (US); Michael D. Danesh, Carson, CA (US)

(73) Assignee: DMF, Inc., Carson, CA (US)

(21) Appl. No.: 18/983,823

(22) Filed: Dec. 17, 2024

Related U.S. Application Data
(63) Continuation of application No. 17/381,147, filed on Jul. 20, 2021, now Pat. No. 12,169,053.
Application No. 17/381,147 is a continuation of application No. 15/688,266, filed on Aug. 28, 2017, now Pat. No. 11,067,231.

(51) Int. Cl. F21S 8/02; F21S 9/02; F21V 17/02; F21V 17/12; F21V 21/04; F21V 23/00; F21V 23/02; F21V 23/04; F21V 23/06; F21Y 115/10

(52) U.S. Cl. CPC F21S 8/026; F21S 9/022; F21V 17/02; F21V 17/12; F21V 21/04; F21V 23/003; F21V 23/026; F21V 23/04; F21V 23/06; F21Y 2115/10

(57) ABSTRACT

Embodiments are directed to a lighting system including a junction box for accommodating a light source assembly, and which is configured to allows for additional components such as separate drivers or emergency ballasts to also be included in the lighting system together with the light source assembly. In embodiments, the junction box is mounted on a pan style frame. In some embodiments, the lighting system includes a test switch mounted on a trim piece that is accessible from below a ceiling in which the lighting system is installed, and which allows for an emergency power supply to be verified.

### CROSS-REFERENCE TO RELATED APPLICATION(S)

The present application is a continuation of U.S. application Ser. No. 17/381,147 filed on Jul. 20, 2021, entitled “ALTERNATE JUNCTION BOX AND ARRANGEMENT FOR LIGHTING APPARATUS,” which is a continuation of U.S. application Ser. No. 15/688,266 filed Aug. 28, 2017, entitled “ALTERNATE JUNCTION BOX AND ARRANGEMENT FOR LIGHTING APPARATUS,” which is incorporated by reference herein in its entirety.

### TECHNICAL FIELD

The present embodiments relate generally to lighting, and more particularly to an apparatus for a downlight or ceiling lamp incorporating an LED lighting source.

### BACKGROUND

The inventions of the present applicant such as those described in U.S. Pat. No. 9,581,302 and U.S. Patent Publ. Nos. 2017/0045213, 2016/0312987, 2016/0348861, 2016/0348860 and 2015/0276185, the contents of which are incorporated herein by reference in their entirety, have dramatically advanced the state of the art of lighting technology. However, opportunities for further improvements remain.

### SUMMARY

Embodiments are directed to a lighting system including a junction box for accommodating a light source assembly, and which is configured to allow for additional components such as separate drivers or emergency ballasts to also be included in the lighting system together with the light source assembly. In embodiments, the junction box is mounted on a pan style frame. In some embodiments, the lighting system includes a test switch mounted on a trim piece that is accessible from below a ceiling in which the lighting system is installed, and which allows for an emergency power supply for the lighting system to be verified.

### BRIEF DESCRIPTION OF THE DRAWINGS

The patent or application file contains at least one drawing executed in color. Copies of this patent or patent application publication with color drawing(s) will be provided by the Office upon request and payment of necessary fee.

These and other aspects and features of the present embodiments will become apparent to those ordinarily skilled in the art upon review of the following description of specific embodiments in conjunction with the accompanying figures, wherein:

FIGS. 1A to 1C are various views of an example lighting system according to the embodiments;

FIG. 2 illustrates another example lighting system according to the embodiments;

FIG. 3 illustrates another example lighting system according to the embodiments; and

FIGS. 4A and 4B illustrates example emergency aspects of a lighting system such as that illustrated in FIG. 3.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

As set forth above, the present applicant has developed several innovations that have dramatically advanced the state of the art of lighting technology. For example, the innovation of U.S. Patent Publ. No. 2016/0312987 is directed to an outer casing and mounting hardware for a recessed lighting fixture that can allow a unified light source and driver module to be adjustably installed behind a ceiling (i.e. the outer casing housing the light source module can be adjustably mounted in different directions with respect to an opening in the ceiling). According to certain aspects, the present applicant has recognized that this and other innovations can be leveraged in certain ways, for example to allow for additional components such as separate drivers or emergency ballasts, to also be included in the light fixture along with the light source module.

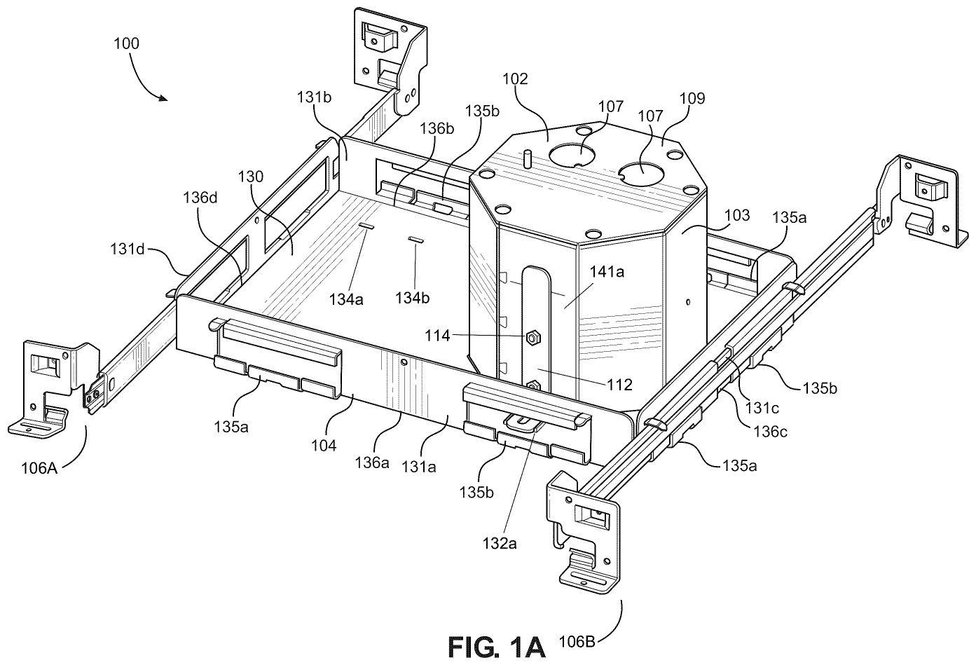

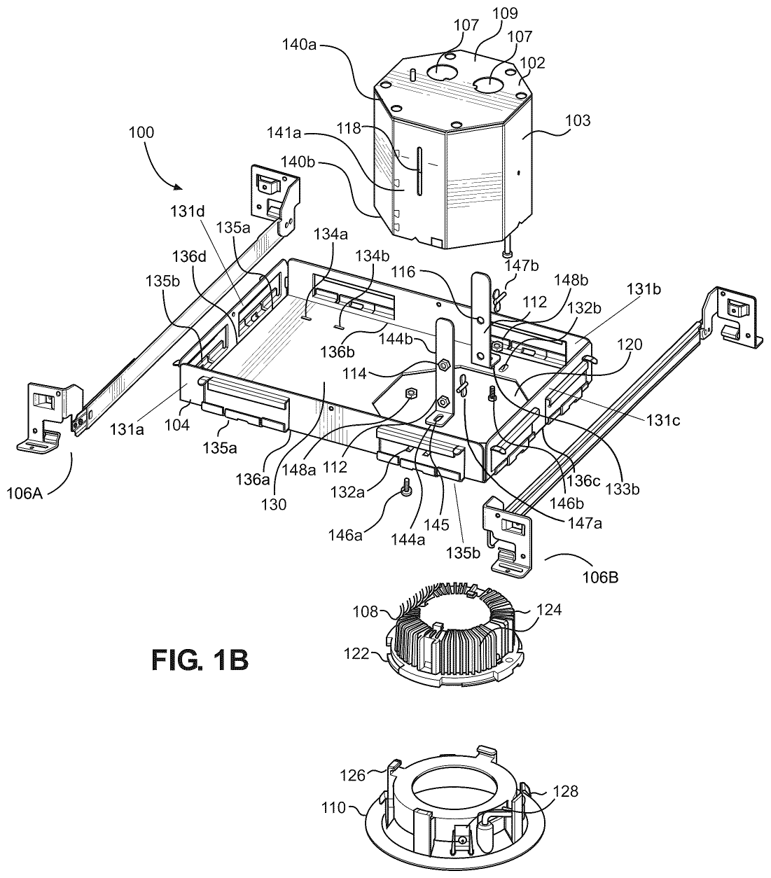

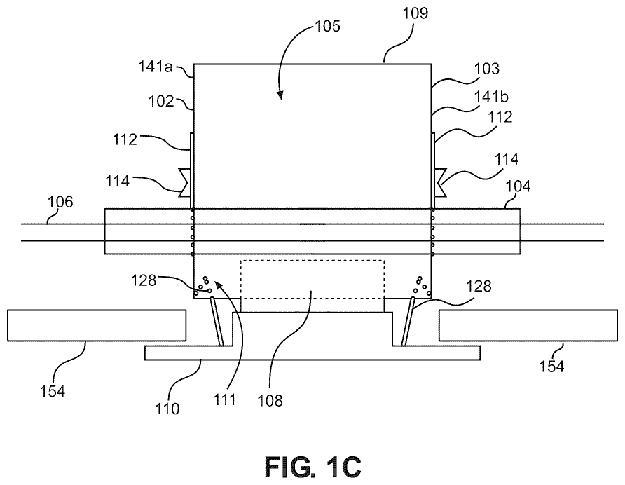

In fulfillment of these and other aspects, FIG. 1A illustrates an example lighting system 100 according to the present embodiments.

As shown, lighting system 100 is comprised of a junction box 102 mounted on a frame 104. In embodiments, junction box 102 may be made of steel, stainless steel, aluminum, plastic, titanium, copper or nickel. Junction box 102 may be fire-resistant in that it has a fire rating of up to two hours without any need for modification, where the fire rating is described in the National Electrical Code (NEC) and by the Underwriters Laboratories (UL) such as specified in UL 263 Standard for Fire Tests of Building Construction and Materials. In other embodiments, lighting system 100 may include a standard 4×4 electrical junction box, which may or may not be fire rated. Moreover, although junction box 102 shown in the example of FIG. 1A as having an octagonal outer shape, this is not necessary. In other embodiments, junction box 102 may have any suitable shape, such as square, rectangle, pentagon, hexagon, heptagon, nonagon, or decagon, or having a rounded shape such as cylindrical, ellipsoid, frusto-conical, or otherwise curved shape. Example aspects of junction box 102 in some embodiments can be found in U.S. Patent Publ. No. 2016/0312987, the contents of which are incorporated herein by reference in their entirety.

Frame 104 is in the form of a pan or tray and may be comprised of steel, stainless steel, aluminum, plastic, titanium, copper or nickel. As further shown, frame 104 is attached to hangar bars 106A and 106B to allow the lighting system to be installed in a typical drop ceiling as will be described in more detail below. Moreover, as further shown, frame 104 is dimensioned to accommodate additional lighting system components other than junction box 102 according to additional aspects of other embodiments to be described in more detail below.

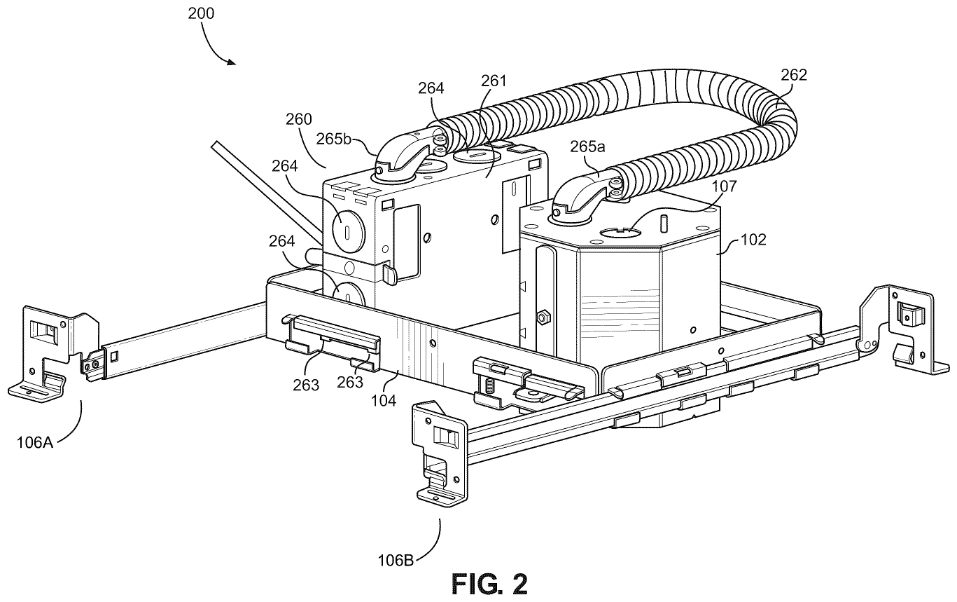

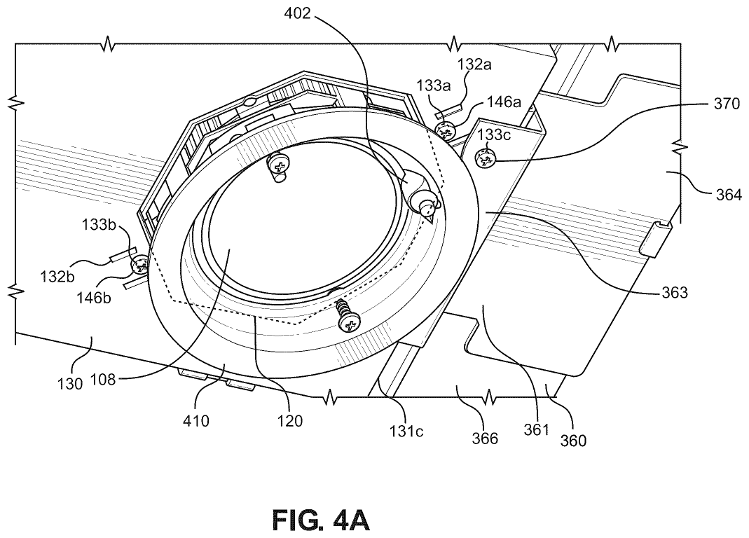

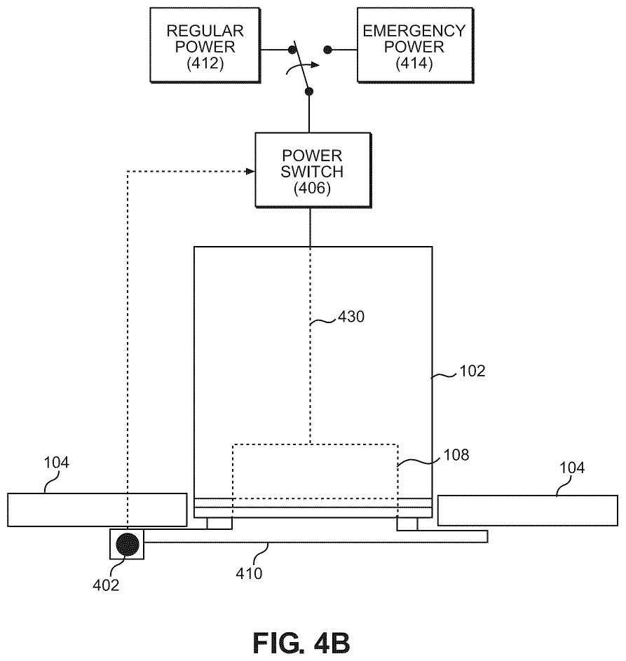

FIG. 1B is an exploded view of example lighting system 100 according to the embodiments. FIGS. 1A and 1B show the frame 104 includes a bottom portion 130 shaped as a rectangle with side portions 131a and 131b formed along long edges 136a and 136b of the bottom portion 130, respectively. Side portions 131c and 131d formed along short edges 136c and 136d, respectively. Each of the side portions 131a-131d includes hanger bar guides 135a and 135b, which allow the respective pairs of hanger bars 106 to be mounted on either the long edges 136a and 136b or the short edges 136c and 136d. As shown in FIG. 1B, the bottom portion 130 of the frame 104 includes an opening 120 disposed closer to the short edge 136c than the short edge 136d to accommodate the junction box 102. The bottom portion 130 of the frame 104 further includes a pair of slots 134a and 134b to couple an external housing 261 (see FIG. 2) to the frame 104. The slots 134a and 134b are colinearly aligned and disposed closer to the short edge 136d than the short edge 136c as shown in FIG. 1B. FIG. 1B also shows the bottom portion 130 of the frame 104 includes two pairs of bracket guides 132a and 132b disposed near the opening 120 and opposite with respect to one another. The pairs of brackets guides 132a and 132b constrain corresponding L-shaped brackets 112 when coupling the L-shaped brackets 112 to the frame 104. FIG. 4A shows the bottom portion 130 of the frame 104 further includes fastener opening 133a disposed partially between the pair of bracket guides 132a and the opening 120 to receive a fastener 146a; FIG. 1B also shows this fastener 146a as well as a nut 148a to securely couple one L-shaped bracket 112 to the frame 104. Similarly, FIGS. 1B and 4A show the bottom portion 130 also includes a fastener opening 133b disposed partially between the pair of bracket guides 132b and the opening 120 to receive a fastener 146b and a nut 148b to securely couple the other L-shaped bracket 112 to the frame 104. FIG. 4A also shows the bottom portion 130 includes a fastener opening 133c disposed between the opening 120 and the short edge 136c to support a ballast support bracket 361.

The junction box 102 may have a side wall 103 that extends from and is joined at its upper edge (or upper end) 140a to a closed base end 109, which together define a cavity 105 therein. The side wall 103 may surround the cavity 105, with its lower edge (or lower end) 140b defining the perimeter of an opening 111 through which various components can be placed inside the cavity 105, including for example, a ring, the light source assembly 108, and the trim 110. The cavity 105 that is formed in the junction box 102 is larger than the outside dimensions of the light source assembly 108 such that the entirety of the light source assembly 108 fits into the cavity 105. The light source assembly 108 may or may not come into direct contact with the side wall 103 of the junction box 102.

The junction box 102 may have on its base end one or more knockouts 107 as shown. The knockouts 107 may be punched through and removed to leave an opening behind on the base end, for electrical wires to be inserted through the opening. One or more knockouts 107 may also have smaller openings in them (e.g., a slit, slot, etc., that is smaller than the opening that results when the knockout 107 has been removed from the base end) that may allow the electrical wires to be inserted through without the need to punch through the knockouts 107. The knockout 107 may be more than ½ inch in diameter. In one embodiment, one or more of the knockouts 107 allow for the installation therethrough of a non-metallic sheathed cable. One or more of the knockouts 107 may also be positioned on the side wall 103 of the junction box 102.

As can be seen in more detail in this view, junction box 102 is attached to frame 104 by a pair of brackets 112 and nuts 114 (e.g. wing nuts). Each bracket 112 is a L-shaped bracket with a first arm 144a and a second arm 144b oriented at a right angle with respect to the first arm 144a. The first arm 144a includes a fastener opening 145, which aligns with the fastener opening 133a (see FIG. 4A) to receive the screw fastener 146a. The second arm 144b includes a fastener opening 116 (also referred to as a through hole 116, see FIG. 1B), which aligns with the slot 118 on the junction box 102. Nuts 114 engage with screws (e.g., see wing fasteners 147a and 147b in FIG. 1B) that extend both through holes 116 of brackets 112 and slots 118 in housing 102 (e.g., see slots 118 formed on the first side 141a and the second side 141b of the side wall 103 in FIGS. 1B and 1C). With such slots 118 and corresponding fastening mechanisms 114 etc., junction box 102 may be slidably repositioned to extend through opening 120 of frame 104 as will be described in more detail below. Another aspect of the example illustrated fasteners between frame 104 and junction box 102 is that they allow for junction box 102 to be selectively removed from frame 104, for example for servicing or replacement of components.

As shown, lighting system 100 further includes light source assembly 108 and trim 110 that can be mounted together to housing 102. As will be described in more detail below, when assembled together, the lighting system 100 is designed to be positioned behind a ceiling or a wall such that the trim 110 extends outside a hole in the ceiling or wall (not shown) and rests flush against the exposed surface of the ceiling or wall.

In this example embodiments, light source assembly 108 is comprised of a housing that includes integrally formed flange portion 122 and fins 124. The housing may be composed of any thermally conductive material so as to help cool the light source assembly 108 during operation. For example, the housing of light source assembly 108 including integrally formed flange portion 122 and fins 124 may be comprised of injection molded thermally conductive plastic. In other embodiments, the housing may be made of aluminum alloys, copper, copper-tungsten pseudoalloy, AlSiC (silicon carbide in aluminum matrix), Dymalloy (diamond in copper-silver alloy matrix), E-Material (beryllium oxide in beryllium matrix), and/or other thermally conductive plastics or ceramics.

Although not shown in detail in FIG. 1B, light source assembly 108 in example embodiments can include an integrated driver such as an electronic circuit or device that supplies and/or regulates electrical energy to a light source and thus power the light source to emit light. This can include any type of power supply circuit, including one that includes power converters, rectifiers, power transistors and the like for delivering an appropriate alternating current (AC) or a direct current (DC) voltage to the light source. Upon receiving electricity, the power supply circuit may regulate current or voltage to supply a stable voltage or current within the operating parameters of the light source. In embodiments, the power supply circuit receives an input current from an electrical power wiring network of the building or structure in which the lighting system 100 is installed, and may drop the voltage of the input current to an acceptable level for the light source (e.g., from 120V-277V to 36V-48V). In these and other embodiments, junction box 102 may include appropriate wiring and other components to allow for such electrical connections. These electrical connections preferably include keyed or interlocking connectors (not shown) within junction box 102 that allow light source assembly 108 to receive power from the electrical power wiring network. Such keyed or interlocking connectors are further preferably configured to allow for manual connection or disconnection without the use of tools.

The light source in light source assembly 108 may be any electro-optical device or combination of devices for emitting light. For example, the light source may have one or more light emitting diodes (LEDs, such as an XLamp LED from Cree), organic light-emitting diode (OLEDs), or polymer light-emitting diode (PLEDs). An example embodiment of light source assembly 108 having an integrated driver that can be used in lighting system 100 of FIG. 1B is described in more detail in U.S. Patent Publication No. 2015/0009676, the contents of which are incorporated herein by reference in their entirety. It should be noted that an integrated driver is not necessary in all embodiments, as will become more apparent below.

In the illustrated example, trim 110 is attached to the flange portion 122 of light source assembly 108 by mutually engaging twist and lock mechanisms 126 built onto trim 110 and inner surface of flange portion 122. When trim 110 and light source assembly 108 are thus joined together, the attached components can then be installed into junction box 102 in a friction fit manner by clips 128 extending from trim 110.

FIG. 1C illustrates aspects of how embodiments of lighting system 100 can be used to provide a downlight in a ceiling.

As shown, frame 104 of lighting system 100 is secured above an opening in ceiling 154 (e.g. to joists or other structures in a drop ceiling) by hanger bars 106. Junction box 102 is mounted to frame 104 above the opening of ceiling 154 by brackets 112, screws 147a and 147b and nuts 114. As described above, light source assembly 108 and trim 110 are coupled together via a twist and lock mechanism and these two components are jointly connected to junction box 102 using clips 128 on trim 110. When light source assembly 108 and trim 110 are thus secured to junction box 102, trim 110 is flush against the surface of ceiling 154, and trim 110 is the only portion of the lighting system 100 that extends outward from the surface of ceiling 154. As further described above, by virtue of slots 118 in junction box 102, junction box 102 can be slidably repositioned to allow trim 110 to be as flush as desirable against the surface of ceiling 154, or otherwise desirably positioned within the opening of ceiling 154, depending on the style and form of trim 110.

In addition to these aesthetically desirable aspects, additional functionally desirable aspects are made possible by lighting system 100 as well. For example, after installation of junction box 102 behind ceiling 154, light source assembly 108 and trim 110 can be freely installed or otherwise accessed from below the ceiling line, without needing to access the space above the ceiling line. For example, after installation into junction box 102, by manipulation of clips 128, light source assembly 108 and trim 110 can be removed. As described above, light source assembly 108 can further be manually disconnected from a power source when junction box 102 includes suitable electrical wiring connectors. After light source assembly 108 and trim 110 are removed, either or both of them can be serviced and replaced, all without the need for accessing junction box 102 or the space behind ceiling 154.

FIG. 2 illustrates another example of a lighting system 200 according to alternative embodiments.

As shown in this example, lighting system 200 includes many of the same components as lighting system 100, and so repeated descriptions thereof are not included here. Meanwhile, lighting system 200 further includes driver 260. This embodiment can be useful when light source assembly 118 (not shown) does not include a unified driver as described above in connection with lighting system 100. This can provide some benefits in some environments, such as lowering thermal extremes in connection with light source assembly 118, and providing for a distribution of heat among components 102, 260.

Similarly as described above, driver 260 can include any type of power supply circuit, including one that includes power converters, rectifiers, power transistors and the like for delivering an appropriate alternating current (AC) or a direct current (DC) voltage to the light source. Upon receiving electricity, the power supply circuit may regulate current or voltage to supply a stable voltage or current within the operating parameters of the light source in lighting assembly 118. In lighting system 200, driver 260 receives an input current from an electrical power wiring network of the building or structure in which the lighting system 200 is installed via junction box 102 and one or more wires in conduit 262. Driver 260 may drop the voltage of the input current to an acceptable level for the light source (e.g., from 120V-277V to 36V-48V) and provide the regulated voltage back to the light source in junction box 102 via one or more additional wires in conduit 262.

In embodiments, driver 260 may include an external housing 261 made of galvanized steel, injection molded plastic, titanium, aluminum, stainless steel, copper or nickel. As such, similarly to junction box 102, driver 260 may be fire-resistant in that it has a fire rating of up to two hours without any need for modification, where the fire rating is described in the National Electrical Code (NEC) and by the Underwriters Laboratories (UL) such as specified in UL 263 Standard for Fire Tests of Building Construction and Materials. FIG. 2 further shows the external housing 261 includes a plurality of knockouts 264 and a plurality of tabs 263 inserted through corresponding slots formed on the bottom portion 130 of the frame 104 (e.g., slots 134a and 134b as shown in FIG. 1B). FIG. 2 also shows the conduit 262 has a first end 265a coupled to the junction box 102 via an opening formed by the removal of one of the knockouts 107 and a second end 265b coupled to the external housing 261 via an opening formed by the removal of one of the knockouts 264. In these and other embodiments, conduit 262 may be flexible metal conduit having a UL rating.

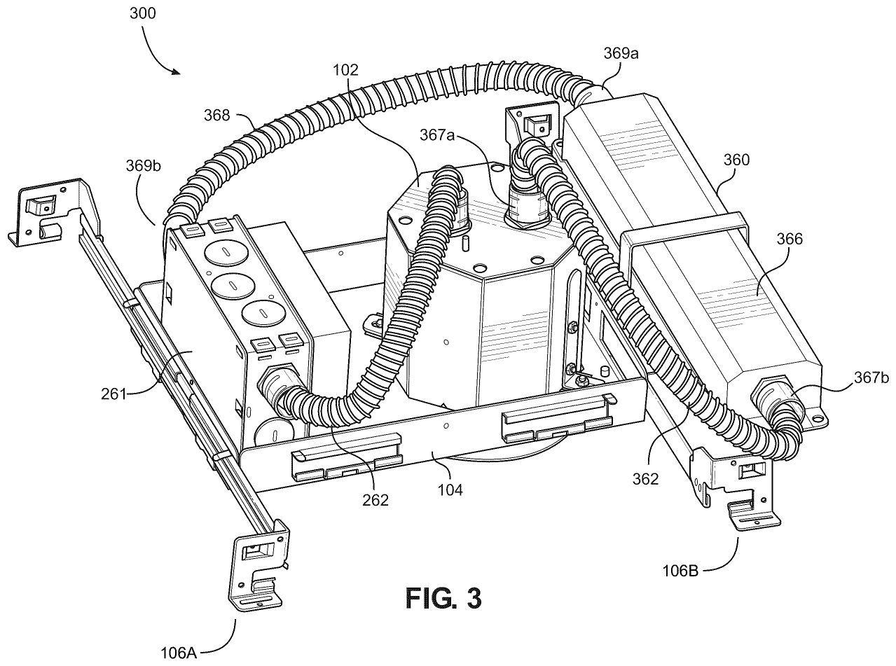

FIG. 3 illustrates another example of a lighting system 300 according to alternative embodiments.

As shown in this example, lighting system 300 includes many of the same components as lighting systems 100 and 200, and so repeated descriptions thereof are not included here. Meanwhile, lighting system 300 further includes an emergency ballast 360.

In embodiments, emergency ballast 360 includes batteries that allow for the continued operation of the light source in light source assembly 108 when electrical power in the building in which lighting system 300 is installed is interrupted or otherwise absent. In these and other embodiments, driver 260 and/or emergency ballast 360 may include relays, switches and similar circuitry for automatically switching the supply of electrical power to light source assembly 108 to be provided from the batteries instead of the building electrical power network during such interruptions via conduit 362. Additionally or alternatively, driver 260 and/or emergency ballast 360 may include converters, regulators, and similar circuitry for automatically charging the batteries via conduit 368 using power received from the building electrical power network when it is not interrupted. The circuitry described herein can be implemented using many ways known to those skilled in the art, and so details thereof will be omitted here for sake of clarity of the invention.

Similar to driver 260, in embodiments, emergency ballast 360 may include an external housing 366 made of galvanized steel, injection molded plastic, or ceramic. As such, similarly to junction box 102 and driver 260, emergency ballast 360 may be fire-resistant in that it has a fire rating of up to two hours without any need for modification, where the fire rating is described in the National Electrical Code (NEC) and by the Underwriters Laboratories (UL) such as specified in UL 263 Standard for Fire Tests of Building Construction and Materials. FIG. 4A shows the ballast 360 is coupled to the frame 104 via a ballast support bracket 361. The ballast support bracket 361 includes a base portion 363 coupled to the bottom portion 130 of the frame 104 via a fastener 370 inserted, in part, through the fastener opening 133c on the bottom portion 130. In FIG. 4A, the trim 110 obscures view of a second fastener inserted through a second fastener opening on the bottom portion 130 of the frame 104 to couple the ballast support bracket 361 to the frame 104. The ballast support bracket 361 further includes a platform 364 connected to the base portion 363 that extends laterally from the short edge 131c of the frame 104 to support the external housing 366. FIG. 3 also shows the conduit 362 has a first end 367a coupled to the junction box 102 via an opening formed by the removal of one of the knockouts 107 and a second end 367b coupled to the external housing 366. FIG. 3 also shows the conduit 368 has a first end 369a coupled to the external housing 366 and a second end 369b coupled to the external housing 261. In these and other embodiments, conduits 362 and 368 may be flexible metal conduit having a UL rating.

Although not shown in detail in FIG. 3, frame 104 of lighting system 300 can include a release mechanism(s) for allowing emergency ballast 360 and/or driver 260 to be easily detached from frame 104 for servicing and/or replacement for example.

FIG. 4A shows an example emergency switch that can be used in together with a lighting system 300 such as that shown in FIG. 3 and described above.

As shown in this example, trim 410 of lighting system 300 includes test button 402. Test button 402 can be connected to an electrical wire (not shown) and electrical signal source and can include any electrical and mechanical components so that, when test button 402 is depressed, an electrical signal is provided on the attached electrical wire and provided to driver 260 and/or emergency ballast 360, and used to test the battery power in emergency ballast 360 as will be described in more detail below.

FIG. 4B illustrates example emergency aspects of lighting system 300 having a test button 402. In this example, lighting system 300 is mounted behind a ceiling 104 as described above in connection with FIG. 1C. As such, when lighting system 300 having trim 410 is so installed, button 402, by virtue of being attached to trim 410, is accessible from below ceiling 104. As further illustrated, when button 402 is pressed, an electrical signal is sent to power switch 406 (e.g. in driver 260 or emergency ballast 360), which causes power to the light source assembly 108 (e.g. via wire(s)/connector(s) 430 routed from the test switch 402 to power switch 406) to be switched from regular power source 412 (e.g. a building electrical wiring network) to an emergency power source 414 (e.g. batteries in emergency ballast 360). If the power in the batteries is sufficient, light from light source assembly 108 will be produced, thereby allowing personnel to verify emergency power source 414 without having to remove lighting system 300 from behind the ceiling or otherwise gain direct access to emergency power source 414.

It should be noted that embodiments are not limited to systems 100, 200 and 300 described herein, and that systems 100, 200 and 300 are not necessarily mutually exclusive. For example, according to certain aspects, the same frame 104 installed in a single building location can accommodate certain components at one time (i.e. some combination or all of junction box 102, driver 260 and ballast 360), and other combinations of components at another time. Additionally or alternatively, any or all of such components can be freely serviced and/or replaced with similar components at any given point in time.

Although the present embodiments have been particularly described with reference to preferred ones thereof, it should be readily apparent to those of ordinary skill in the art that changes and modifications in the form and details may be made without departing from the spirit and scope of the present disclosure. It is intended that the appended claims encompass such changes and modifications.

1. (canceled)

2. An apparatus for a lighting system, the apparatus comprising:
a pan style frame comprising:
a bottom portion comprising an octagonal-shaped frame opening;
a first plurality of hanger bar guides coupled to a first edge of the bottom portion; and
a second plurality of hanger bar guides coupled to a second edge of the bottom portion, the second edge being located opposite to the first edge;
a junction box having an octagonal outer shape, the junction box being configured to be slidably repositionable with respect to the frame through the frame opening, the junction box comprising:
a side wall defining a cavity and an opening into the cavity, the cavity being configured to contain a light source assembly inserted through the opening, the sidewall comprising:
a first slot disposed on a first side of the side wall; and
a second slot disposed on a second side of the side wall opposite to the
first side;
a base end coupled to the side wall; and
a plurality of knockouts;
a first arm coupled to the bottom portion of the frame and extending vertically upward from the bottom portion of the frame, the first arm comprising a first fastener opening aligned to the first slot of the junction box;
a second arm coupled to the bottom portion of the frame and extending vertically upward from the bottom portion of the frame, the second arm comprising a second fastener;
a first fastener inserted through the first fastener opening and the first slot, the first fastener being configured to securely couple the junction box to the first arm;
a second fastener inserted through the second fastener opening and the second slot, the second fastener being configured to securely couple the junction box to the second arm;
a first pair of hanger bars coupled to the first plurality of hanger bar guides; and
a second pair of hanger bars coupled to the second plurality of hanger bar guides.

3. The apparatus of claim 2, wherein the plurality of knockouts comprises:
a first knockout configured to, when removed, allow a non-metallic sheathed cable to pass into the cavity of the junction box; and
a second knockout configured to, when removed, allow a metal conduit to pass into the cavity of the junction box.

4. The apparatus of claim 2, wherein the plurality of knockouts comprises:
one or more knockouts positioned on the side wall of the junction box.

5. The apparatus of claim 2, wherein the junction box is removable from the frame.

6. The apparatus of claim 2, wherein the apparatus meets Underwriters Laboratories (UL) 263 Standard for Fire Tests of Building Construction and Materials.

7. A lighting system, comprising:
the apparatus of claim 2; and
a light source assembly disposed within the cavity of the junction box of the apparatus.

8. The lighting system of claim 7, wherein the light source assembly comprises:
a light source; and
an integrated driver.

9. The lighting system of claim 7, further comprising:
a trim coupled to the light source assembly, the trim being partially disposed within the cavity of the junction box.

10. An apparatus for a lighting system, the apparatus comprising:
a pan style frame comprising:
a bottom portion comprising an octagonal-shaped frame opening;
a first plurality of hanger bar guides coupled to a first edge of the bottom portion; and
a second plurality of hanger bar guides coupled to a second edge of the bottom portion, the second edge being located opposite to the first edge;
a junction box configured to be slidably repositionable with respect to the frame through the frame opening, the junction box having an octagonal outer shape, the junction box comprising:
a side wall defining a cavity and an opening into the cavity, the cavity being configured to contain a light source assembly inserted through the opening;
a base end coupled to the side wall; and
a plurality of knockouts;
a first pair of hanger bars coupled to the first plurality of hanger bar guides; and
a second pair of hanger bars coupled to the second plurality of hanger bar guides.

11. The apparatus of claim 10, wherein the plurality of knockouts comprises:
a first knockout configured to, when removed, allow a non-metallic sheathed cable to pass into the cavity of the junction box; and
a second knockout configured to, when removed, allow a metal conduit to pass into the cavity of the junction box.

12. The apparatus of claim 10, wherein the plurality of knockouts comprises:
one or more knockouts positioned on the side wall of the junction box.

13. The apparatus of claim 10, wherein the junction box is removable from the frame.

14. The apparatus of claim 10, wherein the apparatus meets Underwriters Laboratories (UL) 263 Standard for Fire Tests of Building Construction and Materials.

15. A lighting system, comprising:
the apparatus of claim 10; and
a light source assembly disposed within the cavity of the junction box of the apparatus.

16. The lighting system of claim 15, wherein the light source assembly comprises:
a light source; and
an integrated driver.

17. The lighting system of claim 15, further comprising:
a trim coupled to the light source assembly, the trim being partially disposed within the cavity of the junction box.

18. A lighting system installed in a ceiling, the ceiling comprising a ceiling opening, the lighting system comprising:
an apparatus disposed in the ceiling, the apparatus comprising:
a pan style frame comprising:
a bottom portion comprising an octagonal-shaped frame opening;
a first plurality of hanger bar guides coupled to a first edge of the bottom portion; and
a second plurality of hanger bar guides coupled to a second edge of the bottom portion, the second edge being located opposite to the first edge;
a junction box having an octagonal outer shape, the junction box being configured to be slidably repositionable with respect to the frame through the frame opening, the junction box being aligned to the ceiling opening, the junction box comprising:
a side wall defining a cavity and an opening into the cavity, the sidewall comprising:
a first slot disposed on a first side of the side wall; and
a second slot disposed on a second side of the side wall opposite to the first side;
a base end coupled to the side wall; and
a plurality of knockouts;
a first arm coupled to the bottom portion of the frame and extending vertically upward from the bottom portion of the frame, the first arm comprising a first fastener opening aligned to the first slot of the junction box;
a second arm coupled to the bottom portion of the frame and extending vertically upward from the bottom portion of the frame, the second arm comprising a second fastener;
a first fastener inserted through the first fastener opening and the first slot, the first fastener being configured to securely couple the junction box to the first arm;
a second fastener inserted through the second fastener opening and the second slot, the second fastener being configured to securely couple the junction box to the second arm;
a first pair of hanger bars, coupled to the first plurality of hanger bar guides, to securely couple the apparatus to a structure in the ceiling; and
a second pair of hanger bars, coupled to the second plurality of hanger bar guides, to securely couple the apparatus to the structure in the ceiling; and
a light source assembly disposed within the cavity of the junction box of the apparatus, the light source assembly comprising:
a light source configured to emit light through the opening of the junction box and the ceiling opening; and
an integrated driver.

19. The lighting system of claim 18, further comprising:
a non-metallic sheathed cable inserted into the cavity of the junction box through a knockout opening formed by removing one knockout of the plurality of knockouts.

20. The lighting system of claim 18, further comprising:
a metallic conduit inserted into the cavity of the junction box through a knockout opening formed by removing one knockout of the plurality of knockouts.

21. The lighting system of claim 18, further comprising:
a trim coupled to the light source assembly, the trim being partially disposed within the cavity of the junction box.
